(19) United States
(12) Patent Application Publication
(10) Pub. No.: US 2022/0313407 A1
(43) Pub. Date: Oct. 6, 2022

(54) Teeth Cleaner and System

(71) Applicant: Shiang Yueng Feng, Colleyville, TX (US)

(72) Inventor: Shiang Yueng Feng, Colleyville, TX (US)

(21) Appl. No.: 17/219,843

(22) Filed: Mar. 31, 2021

(51) Int. Cl. A61C 17/20; A61C 17/024

(52) U.S. Cl. CPC A61C 17/20; A61C 17/024

(57) ABSTRACT

The teeth cleaner and system described in this present invention utilizes a mouthpiece that holds an ultrasonic transducer inside the oral cavity. The holding force of the transducer do not impede the ultrasonic vibrations. The mouthpiece ensures adequate cleaning fluid surrounds all teeth in the mouth and positions the cavitation bubble generating ultrasonic transducer adjacent to all teeth. The user changes to a face-down posture, all teeth can easily be submerged in the cleaning liquid and can be cleaned by cavitation bubbles with similar cleaning efficacy on both inside and outside teeth surfaces at the same time. Consumers and hygienists can use this present invention as an alternative tool in routine preventive dental care activities.

### CROSS-REFERENCE TO RELATED APPLICATIONS

This application claims the benefit of U.S. Provisional Application for Patent Ser. No. 63/008,765 filed on Apr. 12, 2020 and titled “Teeth Cleaner and System”.

### FIELD OF INVENTION

This present invention relates to dental cleaning apparatus and more specifically to ultrasonic teeth cleaning systems. The present invention improves upon short-comings of prior arts. Both consumers and hygienists can use the present invention as a preventive dental care tool with a simple posture change of the user.

### PRIOR ARTS

The principles of the teeth cleaning device described in U.S. Pat. No. 4,236,889 has been in use for more than 40 years. A patient lays on his/her back, face up with mouth open; A hygienist directs such a device around the mouth to clean each tooth's surface areas. U.S. Pat. No. 5,730,594 introduces an ultrasonic scaler to augment the effectiveness of the cleaning efforts while the process remains about the same, An ultrasonic cleaner, unrelated to teeth cleaning, was revealed in U.S. Pat. No. 2,896,648 for industrial use and today can be seen used to fast cleaning of various articles including dentures. Taiwan patent number TW I-290460 uses such ultrasonic cleaning technology in a teeth cleaning apparatus. However, the fact that no such teeth cleaning products exist in the market is an evidence that such design has some deficiencies. For example, vibrations generated by its ultrasonic vibrating elements are meant to agitate cleaning liquid above and below its hinged cleaner channels. However, the hinged cleaner channels are in contact with the vibration absorbing soft tissues of the user's inside surfaces of lips and cheeks. At the same time, the user must close his/her lips tight in order to keep cleaning fluid from leaking out of his/her mouth, This holding force direction is in the same direction as the vibrations generated by the ultrasonic vibrating elements. Therefore, ultrasonic vibrations are absorbed by the user's soft tissues of lips and cheeks. The end result totally defeats the purpose of the ultrasonic vibrating elements.

### BRIEF SUMMARY OF THE INVENTION

The Stationary End of a water-proof ultrasonic Transducer is installed in the Transducer Holder of a Mouthpiece while the Vibrator End of said Transducer stays outside of said Transducer Holder. The U-shaped Containment Wall of said Mouthpiece is partially inserted into a user's mouth between his/her outer gums surfaces and internal surfaces of his/her lips and cheeks, forming a Work Cavity surrounding said Transducer and his/her teeth. Short flanges at the edges of said U-shaped Containment Wall of said Mouthpiece are in contact with the outer surfaces of user's gum tissues to ensure adequate space exists between his/her outer teeth surfaces and said U-shaped Containment Wall of said Mouthpiece. Said Vibrator End of said Transducer is located between the user's upper and lower teeth in said Work Cavity. The user orients his/her head to a face-down posture, resulting in his/her end molar teeth, or, wisdom teeth, positioned at the highest point in said Work Cavity. A cleaning liquid pump is turned on to deliver cleaning liquid through a hollow Ingress Tube Connector of said Mouthpiece into said Work Cavity until said Transducer and all teeth are submerged in the cleaning liquid. The Power And Control Unit is turned on to start vibrating said Transducer at a predetermined frequency. Cavitation bubbles created by the vibration of said Transducer can propagate toward both outer and inner teeth surfaces at the same time, achieving similar cleaning efficacy on all teeth surfaces. Turning the power off stops cleaning. Then said Mouthpiece is removed from the user's mouth to discharge cleaning liquid.

### BRIEF DESCRIPTION OF THE DRAWINGS

For a more complete understanding, reference is now made to the following description taken in conjunction with the accompanying Drawings in which:

FIG. 1 shows an exploded view of Mouthpiece Assembly.

FIG. 2 shows 4 different views of Mouthpiece Assembly.

FIG. 3 shows a system of the present invention in relation with the user's mouth and head.

FIG. 4 shows the user's tongue and teeth in relationship with Mouthpiece Assembly in a first section view.

FIG. 5 shows the user's teeth in relationship with Mouthpiece Assembly in a second section view.

FIG. 6 shows an exploded view of Transducer.

### DETAILED DESCRIPTION

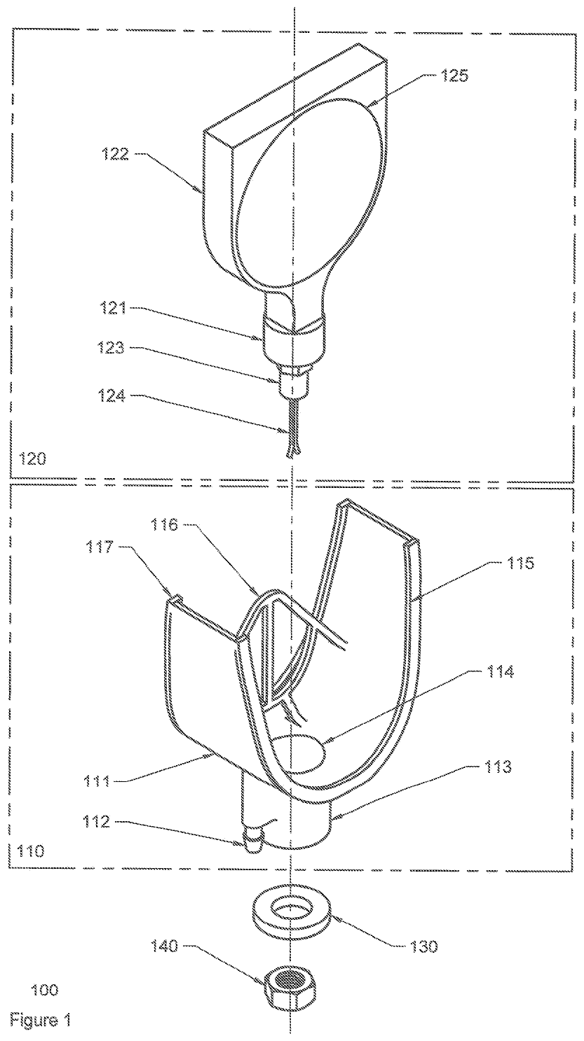

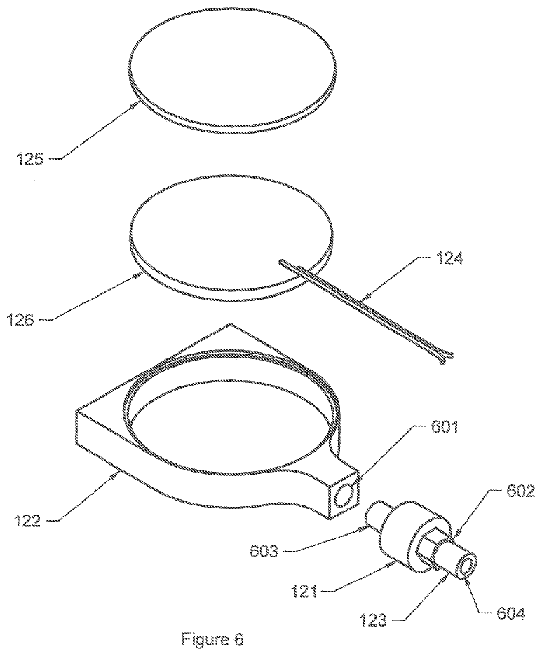

Refer to FIG. 1, an exploded view of the Mouthpiece Assembly 100. To avoid cluttering, hidden lines are not shown. The viewing direction is to look at the front-right-top corner. Mouthpiece Assembly 100 consists of Mouthpiece 110, Transducer 120, Washer 130 and Nut 140. Washer 130 and Nut 140 need no further explanations. Mouthpiece 110 and Transducer 120 are explained in the next 2 paragraphs. An exploded view of Transducer 120 is detailed in FIG. 6.

Mouthpiece 110 is an injection molded component with 7 functional areas including U-shaped Containment Wall 111, a hollow Ingress Tube Connector 112, Holder Body 113 with Holder Hole 114 inside, Upper Flange 115 along one edge of Containment Wall 111, Tongue Guard 116 and Lower Flange 117 along the other edge of Containment Wall 111.

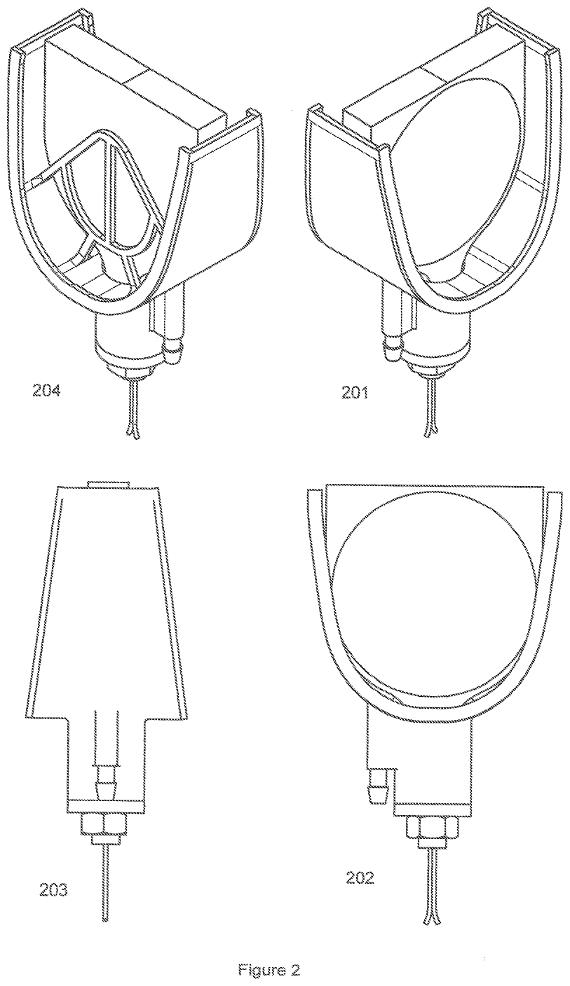

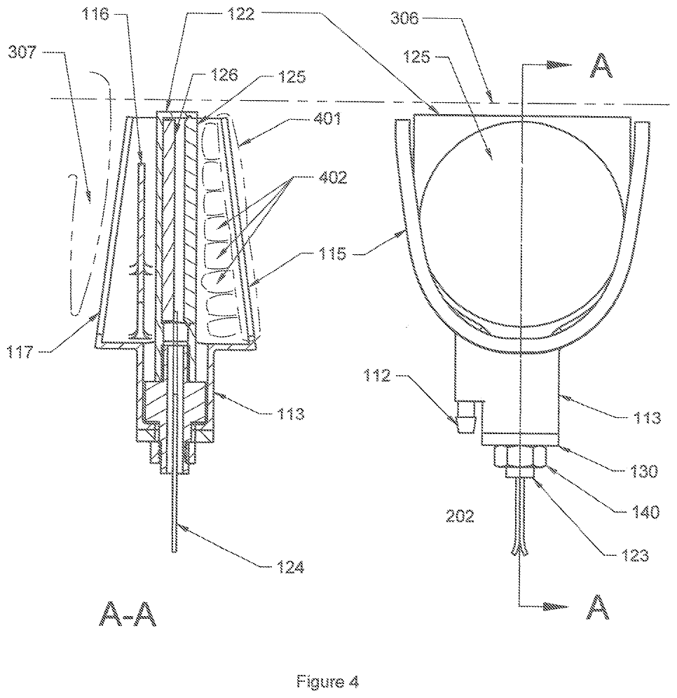

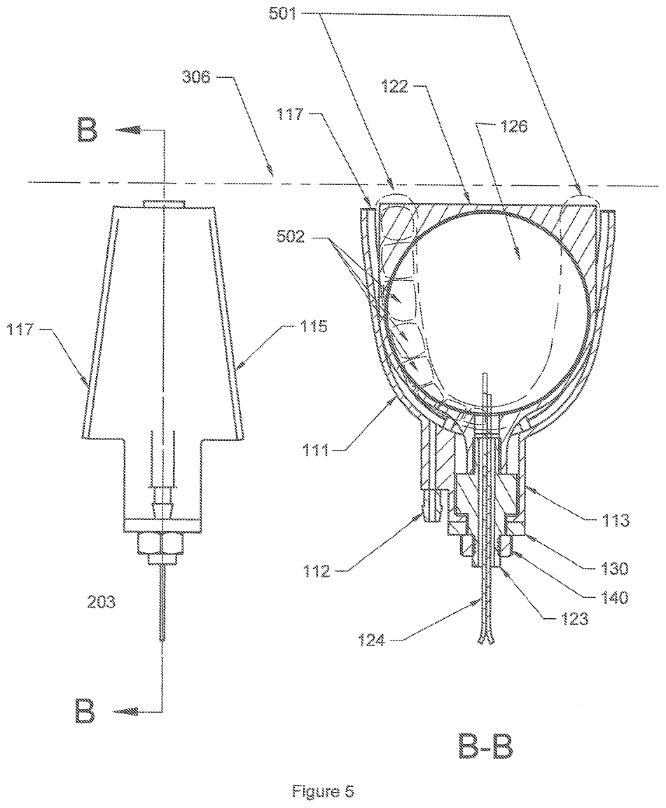

Transducer 120 is an assembly of Stationary End 121 which will be detailed later in FIG. 6 about its several functional areas including Hollow Bolt 123 shown here in FIG. 2. Vibrator Body 122, Electric Wires 124, Lid 125 and piezoelectric ceramic Disc 126 which is hidden inside Vibrator Body 122 and behind Lid 125. Disc 126 will be shown later in FIG. 4 and FIG. 5, Electric Wires 124 are used to deliver power, through Hollow Bolt 123 of Stationary End 121, to Disc 126 affixed to the inside wall of Vibrator Body 122 and sealed by Lid 125. FIG. 6 will explain the assembly steps of Transducer 120.

To assemble Mouthpiece Assembly 100, Stationary End 121 of Transducer 120 is first inserted into Holder Hole 114 of Mouthpiece 100, with Wires 124 and Hollow Bolt 123 extended below Holder Body 113. Washer 130 and Nut 140 are then applied to Hollow Bolt 123 to secure Transducer 110 tightly against the bottom of Holder Hole 114 which has a smaller diameter than Stationary End 121. The resulting Mouthpiece Assembly 100 is shown in 4 different views in FIG. 2 to help visualize Mouthpiece Assembly 100.

Refer to FIG. 2, 4 different views of Mouthpiece Assembly 100. To avoid cluttering, hidden lines are not shown. View 201 is the isometric view in the same orientation as in FIG. 1, looking at the front-right-top corner. View 202 is an orthogonal view looking from the right. View 203 is an orthogonal view 90 degrees from View 202 looking from the front. View 204 is another isometric view looking at the front-left-top corner. These views provide better visualization of all functional areas of both Mouthpiece 110 and Transducer 120.

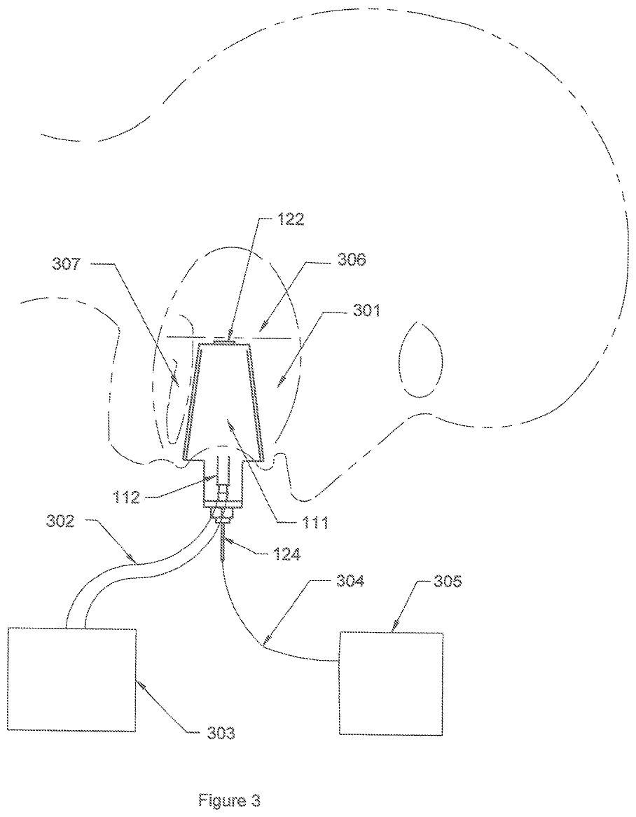

Refer to FIG. 3, a system of the present invention in relation with the user's mouth and head. Physical components of the present invention are drawn in solid lines while supporting articles are drawn in phantom lines. Components previously identified in FIG. 1 retain their identification numbers in FIG. 3. The silhouette of a user's head drawn in phantom lines shows he/she is in a face-down posture. The viewing direction is the same as in View 203 in FIG. 2.

Containment Wall 111 of Mouthpiece Assembly 100 is partially inserted into a user's mouth between his/her outer gums surfaces and internal surfaces of his/her lips and cheeks, forming Work Cavity 301 surrounding his/her teeth, not drawn to avoid cluttering, and Transducer 120 of which only the top of Vibrator Body 122 is drawn. Upper Flange 115 and Lower Flange 117, both not drawn and will be illustrated in FIG. 4 and FIG. 5, are in contact with the users outer gums surfaces to ensure adequate space, for accommodating cleaning liquid, exists between his/her teeth surfaces and U-shaped Containment Wall 111 of Mouthpiece Assembly 100. Said space are not visible in FIG. 3 and will be illustrated in FIG. 4 and FIG. 5.

Tube 302 connects Ingress Tube Connector 112 of Mouthpiece Assembly 100 to Cleaning Liquid Delivery Unit 303 and serves as a conduit for delivering cleaning liquid from Cleaning Liquid Delivery Unit 303 into Work Cavity 301. Cleaning Liquid Delivery Unit 303 includes a cleaning liquid container and a pump that can be turned on and off to deliver cleaning liquid into Work Cavity 301 via Tube 302 and Ingress Tube Connector 112.

Electric Wires 304 are connected to Power And Control Unit 305 to deliver electric power via Wires 124 to Transducer 110 which is inside Work Cavity 301 and only the top portion of Vibrator Body 122 is drawn in FIG. 3. Power And Control Unit 305 includes a power source and an ultrasonic control circuit that can be turned on and off to operate Transducer 120.

The user turns on the pump of Cleaning Liquid Delivery Unit 303 to fill cleaning liquid in Work Cavity 301 up to level 306 so as to partially submerge tongue 307 and totally submerge all of his/her teeth, which will be illustrated in FIG. 4 and FIG. 5. Then, the user turns on Power And Control Unit 305 to start operating Transducer 120 to clean the teeth. Turning off Power And Control Unit 305 terminates the cleaning process. Then, Mouthpiece Assembly 100 is removed from the mouth to discharge cleaning liquid.

Refer to FIG. 4, the user's tongue and teeth in relationship with Mouthpiece Assembly 100 in a first section view. On the right portion of FIG. 4 is the same View 202 as in FIG. 2 with an additional section plane A-A. On the left portion of FIG. 4 is a section view at section plane A-A. Physical components of the present invention are drawn in solid lines while supporting articles are drawn in phantom lines. The user's upper teeth and upper gum are drawn in section view A-A, while lower teeth and lower gum are not drawn to avoid cluttering. Components previously identified in FIG. 1 and FIG. 3 retain their identification numbers in FIG. 4.

Piezoelectric ceramic Disc 126 is affixed to the inside surface of Vibrator Body 122 and sealed by Lid 125. Ultrasonic vibrations of Disc 126 can generate cavitation bubbles on external surfaces of Lid 125 and Vibrator Body 122. Tongue Guard 116 keeps tongue 307 from touching Vibrator Body 122. Upper Flange 115 is in contact with the user's upper gum 401. Upper teeth 402 are totally submerged in cleaning fluid below level 306. Upper teeth 402 are also located close to Lid 125. Lower Flange 117 is in contact with the user's lower gum which is not drawn to avoid cluttering. Lower teeth, also not drawn to avoid cluttering, are totally submerged in cleaning fluid below level 306. Lower teeth are also located close to the external surface of Vibrator Body 122. Cavitation bubbles generated by ultrasonic vibrations of Disc 126 along the edges of Lid 125 and Vibrator Body 122 can propagate over similar distances to reach both inside and outside surfaces of all upper teeth 402 and all lower teeth and achieve similar cleaning efficacy.

Refer to FIG. 5, the user's teeth in relationship with Mouthpiece Assembly 100 in a second section view. On the left portion of FIG. 5 is the same View 203 as in FIG. 2 with an additional section plane B-B. On the right portion of FIG. 5 is a section view at section plane B-B. Physical components of the present invention are drawn in solid lines while supporting articles are drawn in phantom lines. The user's lower gum and lower right teeth are drawn in section view B-B, while the user's lower left teeth are not drawn to avoid cluttering. Components previously identified in FIG. 1 and FIG. 3 retain their identification numbers in FIG. 5.

With Lid 125 out of the way from section view B-B, Disc 126 is shown positioned inside of Vibrator Body 122. Vibrator Body 122 is located closer to the viewer in section view B-B than lower gum 501 and lower teeth 502. Lower Flange 117 is in contact with lower gum 501. All lower teeth 502 are totally submerged below level 306 and have similar distances from the external surface of Vibrator Body 122. Cavitation bubbles generated by ultrasonic vibrations of Disc 126 along the edges of Lid 125 and Vibrator Body 122 can propagate over similar distances to reach both inside and outside surfaces of all upper teeth 402 and all lower teeth 502 and achieve similar cleaning efficacy.

Refer to FIG. 6, an exploded view of Transducer 120 for its assembly procedure. Components previously identified in FIG. 1 retain their identification numbers in FIG. 6. Stationary End 121 consists of functional areas Hollow Bolt 123, Locker Nut 602, Locker Bolt 603 Center Hole 604 which goes through Hollow Bolt 123, Locker Nut 602, Stationary End 121 and Locker Bolt 603. First, solder Wires 124 to the positive and negative poles, respectively, of piezoelectric ceramic Disc 126. Next, run Wires 124 through Threaded Hole 601 on the end of Vibrator Body 122. Next, coat the bottom surface of Disc 126 with high strength epoxy to affix Disc 126 to the internal surface of Vibrator Body 122. Next, apply water proofing material over the top surface of

Disc 126, around the rim of Vibrator Body 122 and inside Threaded Hole 601. Next, press-fit Lid 125 into the rim of Vibrator Body 122. Next, run Wires 124 through Center Hole 604. Next, apply flexible water proofing material over surfaces of Threaded Hole 601 and Locker Bolt 603. Next, apply flexible water proofing material or insert a flexible water proofing o-ring between the square area around Threaded Hole 601 and its mating area on Stationary End 121. Finally, turn Locker Nut 602 to tighten Locker Bolt 603 into Threaded Hole 601 to complete assembly of Transducer 120. When assembling Transducer 120 onto Mouthpiece 100, Washer 130 and Hex Nut 140 are applied to Hollow Bolt 123. The force holding Transducer 120 onto Mouthpiece 100 is along the center line of Center Hole 604.

When power is applied, piezoelectric ceramic Disc 126 affixed to the inside surface of Vibrator Body 122 vibrates along the axle direction of Disc 126 which is perpendicular to the center line of Center Hole 604, or, the direction of force holding together Vibrator End 122 and Stationary End 121. Therefore, the holding force does not impede the vibrations of Disc 126 and the ultrasonic cleaning efficacy is greatly improved upon prior arts.

I claim:

1. A teeth cleaning apparatus comprising:
1.1 a mouthpiece, further comprising:
1.1.1. a containment wall,
1.1.2. an ingress connector extruding from said containment wall and having a hole through said containment wall,
1.1.3. a vibrator holder, and
1.1.4. a vibrator, further comprising a stationary part and a vibrator part, wherein the stationary part of said vibrator is held in said vibrator holder and the vibrator part of said vibrator is positioned near said containment wall;
1.2 a cleaning liquid supply means, further comprising a cleaning liquid reservoir, at least a connecting tube, and a cleaning liquid delivery element to deliver cleaning liquid from said cleaning liquid reservoir through said hole of said ingress connector of said mouthpiece; and
1.3 a power and control unit wherein said power and control unit provides electric power to operate said vibrator of said mouthpiece to vibrate at a frequency capable of producing cavitation bubbles to clean teeth.

2. The teeth cleaning apparatus of claim 1, wherein said containment wall has short flanges along its edges.

3. The teeth cleaning apparatus of claim 1, wherein said vibrator of said mouthpiece is a piezoelectric transducer.

4. The teeth cleaning apparatus of claim 1, wherein said vibrator of said mouthpiece is a electro-mechanical vibrator.

5. The teeth cleaning apparatus of claim 1, wherein said vibrator of said mouthpiece is a mechanical vibrator.

6. The teeth cleaning apparatus of claim 1, wherein said cleaning liquid delivery element is a pump driven element.

7. The teeth cleaning apparatus of claim 1, wherein said cleaning liquid delivery element is a gravity driven element.

8. A method of cleaning teeth of a person in a face-down posture using the teeth cleaning apparatus of claim 1 in steps comprising:
8.1 partially inserting said mouthpiece into said person's mouth, positioning said vibrator part of said vibrator of said mouthpiece inside said person's oral cavity, and positioning the bottom of said containment wall of said mouthpiece below said person's mouth opening to function as a barrier to hold cleaning liquid in said person's oral cavity;
8.2 using said cleaning liquid supply means to fill cleaning liquid in said person's oral cavity up to a level higher than all of said person's teeth;
8.3 turning on power of said power and control unit to operate said vibrator of said mouthpiece and generate cavitation bubbles to clean said person's teeth submerged in said cleaning liquid inside said person's oral cavity.
